(19) United States
(12) Patent Application Publication
(10) Pub. No.: US 2013/0022340 A1
(43) Pub. Date: Jan. 24, 2013

(54) APPARATUS FOR DELIVERING A MEDIUM AT AN ADJUSTABLE TEMPERATURE

(71) Applicant: Gerhard KURZ, Althengstett (DE)

(72) Inventor: Detlef SCHULZ, ALTENRIET (DE)

(73) Assignee: Gerhard KURZ, ALTHENGSTETT (DE)

(21) Appl. No.: 13/623,966

(22) Filed: Sep. 21, 2012

Related U.S. Application Data
(63) Continuation of application No. PCT/EP2011/054555, filed on Mar. 24, 2011.

(30) Foreign Application Priority Data
Mar. 25, 2010 (DE) 10 2010 012 868.6

(51) Int. Cl. H05B 3/58

(52) U.S. Cl. 392/472

(57) ABSTRACT

An apparatus for delivering a medium at an adjustable temperature, comprising a pump, a hose having one end connected to the pump, and the other end for delivering the medium, a heating element provided along a portion of the hose such that the medium flowing through the hose is heated, wherein a thermal resistance is present between the heating element and the medium, and a circuit for adjusting the temperature of the heating element. A resistance detection device connected to the heating element detects the resistance of the heating element. A power detection device connected to the heating element detects the power supplied to the heating element, and a control device establishes the temperature of the medium on the basis of the values established by the resistance detection device and the power detection device, and adjusts the temperature of the heating element according to said established temperature of the medium.

### CROSS-REFERENCES TO RELATED APPLICATIONS

This application is a continuation of copending international patent application PCT/EP2011/054555 filed on Mar. 24, 2011 and designating the U.S., which claims priority of German patent application DE 10 2010 012 868.6 filed on Mar. 25, 2010. The entire contents of these priority applications are incorporated herein by reference.

### BACKGROUND OF THE INVENTION

The present invention relates to an apparatus for delivering a medium at an adjustable temperature, said apparatus comprising a pump, a hose, of which one end is connected to the pump, and of which the other end is provided for delivery of the medium, a heating element, which is provided along a portion of a hose in such a way that the medium flowing through the hose is heated, wherein a thermal resistance is present between the heating element and the medium, and a circuit for adjusting, for example controlling, the temperature of the heating element. The invention also relates to a method for regulating/controlling the temperature of a medium in such an apparatus and to a method for calibrating such an apparatus.

In many fields of technology it is necessary to transport a medium, in particular a liquid medium, from a storage container to a site removed therefrom so as to use said medium at said site. The medium very often has to be heated, or at least kept at a specific temperature, during transport from the storage container to the site of use. For this purpose, electrical heating elements, which generate the necessary heat, are installed in the hose provided to transport the medium.

The adjustment of the temperature of the medium is problematic, since the parameters often change during operation. For example, imagine that transport of the medium is interrupted for a short period. If the heating elements remain on, the medium, which is no longer flowing, may overheat and therefore may be destroyed. If the heating elements are switched off, the medium may cool too quickly and then, once transportation has been resumed, may be too cold at the site of use.

### SUMMARY OF THE INVENTION

On this basis, the object of the invention is to develop an apparatus of the type described in the introduction, in such a way that the temperature of the medium can be regulated/controlled by simple, cost-effective means.

This problem is solved by the apparatus described in the introduction in that a resistance detection device is provided, which is connected to the heating element and is designed to detect the resistance of the heating element, a power detection device is provided, which is connected to the heating element so as to detect the fed electrical power, and a control device is provided, which is designed to establish the temperature of the medium on the basis of the values established by the resistance detection device and the power detection device and, under consideration of the thermal resistance, to adjust the temperature of the heating element according to said established temperature of the medium.

This solution according to the invention is based on the idea that, when calculating the temperature of the medium and therefore when regulating the temperature, the thermal resistance of the system is also to be taken into consideration. The thermal resistance describes, so to speak, the loss of temperature from the heating element to the medium. By establishing the temperature at the heating element and the electrical power fed to the heating element, the temperature of the medium can be established with consideration of the thermal resistance. Based on the established temperature value of the medium, the electrical power fed to the heating element can then be adjusted or regulated so as to achieve the desired temperature of the medium.

The advantage of this apparatus, inter alia, is that the regulation takes place in a very stable manner, even if the parameters, that is to say transport speed of the medium for example, change. For example, the regulation/control device can determine very quickly if the medium is heating excessively due to a slower transport speed, so as to then, by way of response, reduce the electrical power supplied to the heating element.

A further advantage of the apparatus according to the invention is that no temperature sensors are required for the regulation/control process. This contributes to a reduction in cost and, for example, also simplifies the replacement of a hose.

In a preferred development, the heating element is produced from a material which has a temperature coefficient which differs considerably from zero.

This measure is advantageous in particular when calibrating the system, since it is also possible to work with relatively large tolerances without detriment to the accuracy of the temperature regulation. The materials often used for heating elements, such as constantan, have a temperature coefficient which is too low, which would be disadvantageous.

In a preferred development, a calibration value storage device is provided, in which calibration values are stored, in particular a resistance value of the heating element for a reference temperature, a temperature coefficient and a thermal resistance value.

It is further preferred to supply the heating element with a supply voltage via a half-wave control circuit or a full-wave control circuit, wherein the half-wave control circuit or full-wave control circuit is controlled by the control device.

This measure has the advantage that radio interference and large rises in current can be avoided by feeding the heating element only a half-wave of a supply alternating voltage in each case, wherein the switch element necessary for this, such as a TRIAC, is switched on and off at the voltage zero crossing.

In a preferred development, a temperature detection device is provided, which is designed to detect the temperature of the medium in the region of one end. A calibration device is also preferably provided, and is designed to determine predefined specific values of the device, in particular the thermal resistance value, temperature coefficient and resistance value of the heating element for a reference temperature.

The temperature detection device is not used during normal operation of the apparatus, but is used merely to establish temperatures during a calibration process, which is carried out by the calibration device. The temperature detection device may comprise an NTC element for example.

With the aid of the calibration device, it is possible to establish certain apparatus-specific values on the basis of different temperature measurements and resistance measurements at the heating element. These calibration values are then stored in the calibration value storage device.

The object of the invention is also solved by a method for regulating/controlling the temperature of a medium, said method comprising the following steps:

detecting the resistance value of the heating element,

establishing the heating element temperature corresponding to this resistance value,

detecting the electrical power fed to the heating element,

calculating the temperature of the medium in the hose on the basis of the heating element temperature, the electrical power, and a thermal resistance value, and

adjusting the electrical power fed to the heating element according to the calculated temperature of the medium.

The advantages of this method according to the invention correspond to the advantages already explained in conjunction with the apparatus according to the invention, and therefore do not have to be discussed in greater detail. It should merely be mentioned that this method makes do without the use of temperature measurement devices. Merely the detection of the resistance value of the heating element, in order to draw a conclusion regarding the temperature of the heating element, and the detection of the electrical power fed to the heating element are sufficient. With the aid of these two measured variables and the thermal resistance value, which for example can be established in a calibration method, the temperature of the medium can be calculated as an actual variable for the regulation process.

In a preferred development, the resistance value of the heating element is detected in periods in which the heating element is not supplied with electrical energy for heating.

This measure has the advantage that a very accurate resistance measurement is possible. Of course, it would also be conceivable to detect the resistance value during a heating phase, or for example to detect the electrical voltage fed to the heating element in the zero crossing.

In a preferred development of the method according to the invention, the resistance value of the heating element is established via a resistance ratio measurement.

This measure has the advantage that it is very accurate.

Of course, there are also other possibilities for establishing the resistance value of the heating element.

The invention also relates to a method for calibrating an apparatus according to the invention, said method comprising the following step:

pumping the medium through the hose and back to the pump, wherein the following steps are carried out during this process:
the resistance value of the heating element, which is switched off, and the temperature of the medium at one end of the hose are detected after a first, predefinable period of time,
the heating element is switched on,
the resistance value of the heating element and the temperature of the medium are detected after a second, predefinable period of time,
the heating element is switched off,
the resistance value of the heating element and the temperature of the medium are detected after a third, predefinable period of time, and
the resistance value of the heating element at a reference temperature, the temperature coefficient, and the thermal resistance are established on the basis of the detected resistance values and temperatures.

In other words, a medium, for example water, is first pumped in the circuit through the hose, wherein the heating element takes on the temperature of the medium since it, itself, is not supplied with electrical energy. After a first, predefinable period of time, the resistance value of the heating element is then detected, and the temperature of the circulating medium is measured by a temperature sensor. The resistance value and temperature value form a first value pair.

The heating element is then operated, preferably at full power, so that the flowing medium is heated slowly. After a predefinable period of time, for example seven minutes, the resistance of the heating element is detected, and the temperature of the medium is established. Due to the thermal resistance present between the heating element and medium, it can be assumed that the temperature of the heating element is greater than the temperature of the medium. The resistance value of the heating element and the measured temperature of the medium form a further value pair.

Lastly, the heating element is switched off so that the temperature of the heating element and the temperature of the medium assimilate slowly. After a predefinable period of time, for example one minute, the resistance value of the heating element is detected, and the temperature of the medium is measured. The resistance value and temperature thus form a further value pair.

Different variables can be calculated on the basis of these three value pairs, in particular the resistance value of the heating element at a reference temperature, for example 25° C., and the temperature coefficient and the thermal resistance.

For example, the thermal resistance can be established on the basis of the difference between the temperature of the heating element and the measured temperature of the medium, and on the basis of the power fed to the heating element.

It is understood that the above-mentioned features and those yet to be explained below can be used not only in the combinations specified, but also in other combinations or alone, without departing from the scope of the present invention.

### BRIEF DESCRIPTION OF THE DRAWINGS

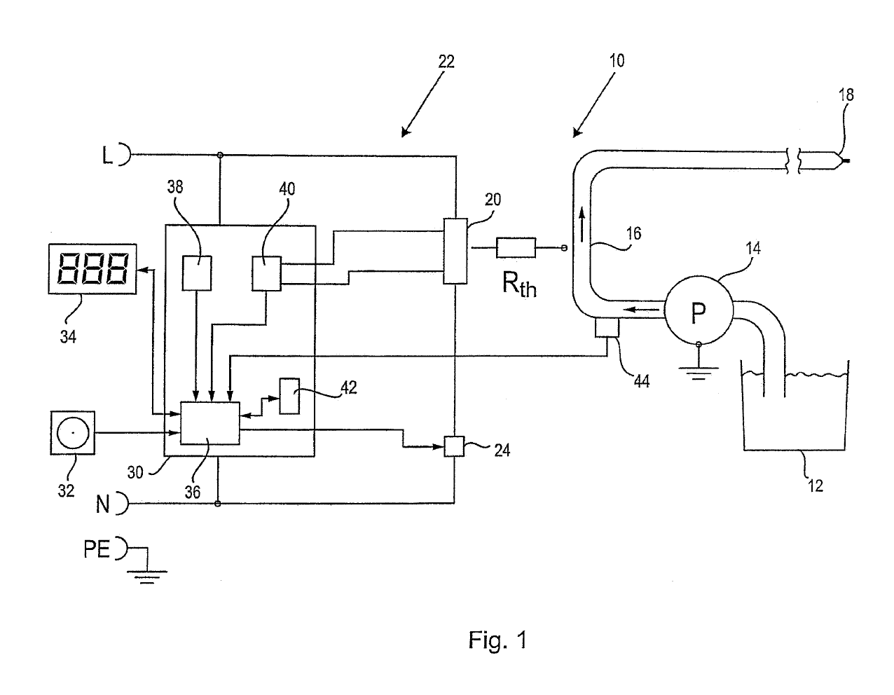

Further advantages and embodiments of the invention will emerge from the description and the accompanying drawing. FIG. 1 shows a schematic illustration of an apparatus according to the invention.

### DETAILED DESCRIPTION OF PREFERRED EMBODIMENTS

FIG. 1 shows a schematic illustration of a system adapted to apply a liquid medium, for example paint or varnish, to a surface to be treated. The system is denoted generally by reference sign 10.

The system 10 comprises, inter alia, a storage container 12, in which the medium to be processed, that is to say paint or varnish for example, is stored.

The system 10 further comprises a pump 14, of which the intake side is connected via a pipe connection or hose connection to the storage container 12. The delivery side of the pump 14 is connected to a hose 16, of which the end 18 remote from the pump 14 has an injection valve for example.

It is noted at this juncture that only those components of the system necessary to understand the invention are shown in the figure. It is understood that further component parts are provided for operation of such a system.

So as to heat the medium pumped from the storage container 12, or to maintain the temperature of said medium, the hose 16 is provided with a heating element, which is denoted in the figure by reference sign 20. The heating element 20 extends over a large part of the length of the hose 16 so that it is possible to introduce heat into the medium during practically the entire circulation through the hose 16. For example, the heating element 20 may be a heating wire, which generates heat over its entire length by application of a voltage.

The heating element 20 is part of a control and regulation device, which is denoted by reference sign 22.

The control and regulation device 22 is used to feed enough energy to the heating element 20 that the medium delivered at the end of the hose 16 has a predefinable temperature.

The control and regulation device 22 is connected to an a.c. voltage network, which supplies the necessary energy both for the heating element 20 and for the other components. A switch element 24, which switches the heating element 20 on and off in a controlled manner, is arranged in series with the heating element 20. The heating element 20 is preferably only switched on for a half-wave, and is switched off again during the subsequent half-wave so as to thus prevent radio interference and large increases in current. The switch element 24 may be a TRIAC for example.

The control and regulation device 22 also has a control circuit 30, which is designed to control the switch element 24 in such a way that a predefinable temperature of the medium is achieved. The desired temperature of the medium can be adjusted, for example, via a control element 32, which is connected to the control circuit 30. In addition, the temperature of the medium can be displayed to the user via a digital display device 34, which likewise is connected to the control circuit 30.

The control circuit 30 itself has a controller 36, which receives data from a power detection device 38 and a resistance detection device 40. In addition, the controller 36 has access to a memory 42, in which the calibration values are stored.

The power detection device 38 is designed to detect the electrical power fed to the heating element 20.

The resistance detection device 40 is connected to the heating element 20 and is used to detect the resistance value (ohmic resistance) of the heating element 20. There are different possibilities for this, wherein a resistance ratio measurement is preferably used.

The system 10 also has a temperature measurement element 44, which is arranged at the pump-side end of the hose 16 so as to measure the temperature of the medium. The temperature measurement element 44 is electrically connected to the controller 36. The temperature measurement element 44 may be an NTC component for example.

It should be noted at this juncture that the temperature measurement element 44 is only used during a calibration phase of the control and regulation device. The information supplied by the temperature measurement element 44 is not required during normal operation of the system 10.

It will now be described hereinafter how the temperature of the medium is regulated. The regulation process is based on the idea of also taking into consideration the thermal resistance Rₜₕ between the heating element 20 and the medium located in the hose 16. This thermal resistance is not necessarily constant, but is a system-specific variable, which can be calculated over the course of a calibration method, which will be discussed in detail further below.

During normal operation of the system 10, the medium pumped through the hose 16 is heated via the heating element 20. The controller 36 controls the switch element 24 for this purpose. Due to the thermal resistance, however, it is to be assumed that medium flowing through the hose 16 will not have the same temperature at the end as the heating element 20. In other words, it is assumed that, to achieve a specific temperature of the medium, the heating element 20 must have a value which is higher by a specific margin.

To determine the temperature of the heating element 20, a resistance measurement is taken via the resistance detection device 40, wherein the measured resistance value can be used to draw a conclusion regarding temperature. To this end, however, a resistance reference value, for example for the temperature 25° C., and the temperature coefficient a of the heating element 20 are required. With the aid of the formula:

R(T)=R(T_{ref})·(1+α·ΔT),

it is possible to establish the temperature which belongs to a specific resistance value R(T) of the heating element 20. Merely the resistance value R(T_{ref}) and the temperature coefficient, which are stored in the memory 42, are necessary for this.

If the temperature at the heating element 20 is known, the temperature of the medium T_{medium} can be determined with the aid of the thermal resistance Rₜₕ and the electrical power fed to the heating element 20, which is established by the power detection device 38. The formula for this is as follows:

T_{medium}=Tₕ−Rₜₕ·L,

wherein Tₕ is the temperature of the heating element 20 and L is the power fed to the heating element 20.

As a result of this relation, the power can be controlled via the controller 36 and the switch element 24 in such a way that the desired temperature T_{medium} is reached and maintained.

The resistance of the heating element 20 can be measured as often as necessary, wherein the measurement is preferably taken when the switch element 24 is switched off.

As mentioned before, the controller 36 requires a plurality of system-specific variables, namely the temperature coefficient, the resistance value of the heating element 20 at a reference temperature, and the thermal resistance Rₜₕ. These three variables can be established with the aid of a calibration method.

To this end, a medium, for example water, is pumped through the hose 16, and the medium exiting at the end 18 is fed back to the intake side of the pump 14, thus forming a circuit.

The temperature measurement element 44 is activated during the calibration method and measures the temperature of the medium at the start of the hose 16.

In a first phase, which for example lasts approximately one minute, the medium is pumped through the hose 16, wherein the heating element 20 is switched off. At the end of this first phase, the temperature of the medium is measured via the temperature measurement element 44, and the resistance value of the heating element 20 is also measured. The obtained value pair R1, T1 is stored.

In the subsequent, second phase, which lasts seven minutes in the present exemplary embodiment, the heating element 20 is operated at full power. At the end of this phase, the temperature of the medium is measured again, as is the resistance value of the heating element 20. The corresponding value pair R3, T3 is again stored. In addition, the electrical power fed to the heating element 20 is also detected and stored as the value L.

In the subsequent, third phase, which for example lasts for one minute, the heating element 20 is again switched off. At the end of this phase, the resistance of the heating element 20 and the temperature of the medium are established. The resultant value pair R2, T2 is again stored.

The resistance reference value R(T_{ref}) is determined on the basis of the value pairs R1, T1 and R2, T2, wherein it is assumed that, in each case, the medium has the same temperature as the heating element 20.

The temperature coefficient α can then be calculated on the same assumption, wherein the two value pairs R1, T1 and R2, T2 are used for this purpose. The temperature coefficient α can be calculated on the basis of the formula:

R2=R1·(1+α·(T2−T1)).

With the aid of the value pair R3, T3 and the detected electrical power which has been fed to the heating element 20, the thermal resistance Rₜₕ can then be calculated as follows:

Rₜₕ=(Tₕ₃−T3):L,

wherein Tₕ₃ is the temperature of the heating element which emerges from the resistance value R3. The temperature T3 is the temperature of the medium measured by the temperature measurement element 44.

The calculated thermal resistance Rₜₕ is then stored in the memory 42, together with the other calculated variables. The resistance value for a reference temperature, the temperature coefficient of the heating element 20, and the thermal resistance are consequently stored in the memory 42. These variables are required for the regulation process, as was described previously.

On the whole, it is thus demonstrated that the temperature of the medium can be regulated in a very simple manner, without the need for temperature sensors along the hose 16. In addition, all variables required for the regulation process can be established automatically by the calibration method according to the invention. Of course, the regulation process would also function if these variables were not stored automatically in the memory 42 via a calibration method, but instead were determined and stored manually.

What is claimed is:

1. An apparatus for delivering a medium at an adjustable temperature, said apparatus comprising:
a pump,
a hose, of which one end is connected to the pump, and of which the other end is provided for delivery of the medium,
a heating element, which is provided along a portion of the hose in such a way that the medium flowing through the hose is heated, wherein a thermal resistance is present between the heating element and the medium,
a circuit for adjusting the temperature of the heating element,
a resistance detection device, which is connected to the heating element and is designed to detect the resistance of the heating element,
a power detection device, which is connected to the heating element so as to detect the fed electrical power, and
a control device, which is designed to determine the temperature of the medium on the basis of the values established by the resistance detection device and the power detection device and under consideration of the thermal resistance, to adjust the temperature of the heating element according to said established temperature of the medium.

2. The apparatus as claimed in claim 1, wherein the heating element is produced from a material which has a temperature coefficient which differs considerably from zero.

3. The apparatus as claimed in claim 1, wherein a calibration value storage device is provided, in which calibration values are stored, in particular a resistance value of the heating element for a reference temperature, a temperature coefficient, and a thermal resistance value.

4. The apparatus as claimed in claim 1, wherein the heating element is supplied with a supply voltage via a half-wave control circuit or a full-wave control circuit, wherein the half-wave control circuit or full-wave control circuit is controlled by the control device.

5. The apparatus as claimed in claim 1, wherein a temperature detection device is provided, which is designed to detect the temperature of the medium in the region of one end.

6. The apparatus as claimed in claim 1, wherein a calibration device is provided, which is designed to determine predefined specific values of the apparatus, in particular the thermal resistance value, temperature coefficient, and resistance value of the heating element for a reference temperature.

7. A method for controlling the temperature of a medium in an apparatus as claimed in claim 1, said method comprising the following steps:
detecting the resistance value of the heating element,
establishing the heating element temperature corresponding to this resistance value,
detecting the electrical power fed to the heating element,
calculating the temperature of the medium in the hose on the basis of the heating element temperature, the electrical power, and a thermal resistance value, and
adjusting the electrical power fed to the heating element according to the calculated temperature of the medium.

8. The method as claimed in claim 7, wherein the resistance value of the heating element is detected in periods in which the heating element is not supplied with electrical power for heating.

9. The method as claimed in claim 7, wherein the resistance value of the heating element is established via a resistance ratio measurement.

10. A method for calibrating an apparatus as claimed in claim 1, said method comprising:
pumping the medium through the hose and back to the pump, wherein the following steps are carried out during this process:
the resistance value of the heating element, which is switched off, and the temperature of the medium at one end of the hose are detected after a first, predefinable period of time,
the heating element is switched on,
the resistance value of the heating element and the temperature of the medium are detected after a second, predefinable period of time,
the heating element is switched off,
the resistance value of the heating element and the temperature of the medium are detected after a third, predefinable period of time, and
the resistance value of the heating element at a reference temperature, for example 25° C., the temperature coefficient, and the thermal resistance are established on the basis of the detected resistance values and temperatures.

11. The method as claimed in claim 10, wherein the thermal resistance is calculated as
Rₜₕ=ΔT/L,
wherein ΔT is the difference from the temperature of the heating element established from the resistance thereof and the measured temperature of the medium, and L is the electrical power fed to the heating element.
